(19) United States
(12) Patent Application Publication
(10) Pub. No.: US 2026/0283142 A1
(43) Pub. Date: Sep. 24, 2026

(54) TAG HOLDING DEVICE AND METHODS FOR PERFORMING THE SAME

(71) Applicant: Patrick Falenwolfe, Slatington, PA (US)

(72) Inventor: Patrick Falenwolfe, Slatington, PA (US)

(21) Appl. No.: 19/389,979

(22) Filed: Nov. 14, 2025

Related U.S. Application Data
(60) Provisional application No. 63/773,951, filed on Mar. 18, 2025.

(51) Int. Cl. A01M 31/00; F16M 13/02

(52) U.S. Cl. CPC A01M 31/00; F16M 13/02

(57) ABSTRACT

A tag holding device for holding a hunting tag of a harvested animal includes an auger body including a non-tapered segment and a tapered segment located distal to the non-tapered segment; a cap body having an annular projection and an attachment channel extending through the annular projection; and an attachment device configured to extend through the attachment channel; wherein: the cap body is configured to removably attach to the non-tapered segment of the auger body, the auger body further includes an auger cavity, and the cap body further includes a cap cavity, and the auger cavity and the cap cavity, in use, encapsulate the hunting tag.

### STATEMENT OF RELATED APPLICATION(S)

This application claims the benefit of U.S. Provisional Patent Application No. 63/773,951 filed on Mar. 18, 2025, entitled “Tag Holding Device and Methods or Performing the Same”, the disclosure of which is hereby incorporated by reference herein in its entirety.

### TECHNICAL FIELD

This invention relates to the field of hunting, particularly with respect to accessories for after the animal is harvested.

### BACKGROUND

Hunting remains a popular activity among many outdoor enthusiasts, whether it be for sport, food, or population control. Most states and municipalities require a hunter to carry a valid hunting license and to apply a tag to the harvested animal, in order to ensure that the hunter has paid the appropriate fees and is not harvesting animals beyond the allowed limit (to maintain healthy animal population numbers). As existing tags are applied manually to the harvested animal in the field, such as by piercing the cartilage of the animal's ear, tags may easily tear or otherwise be accidentally lost from the harvested animal during transport out of the hunting area. If the harvested animal is observed without a proper tag by a game warden or other state/municipal authority, the hunter faces a potential fine for an improperly tagged animal.

Therefore, a need exists for a device to securely affix a hunting tag to a harvested animal which is resistant to accidental dislodgement during transport.

### SUMMARY

A first aspect of the present invention includes a tag holding device for holding a hunting tag of a harvested animal including an auger body comprising a non-tapered segment and a tapered segment located distal to the non-tapered segment; a cap body having an annular projection and an attachment channel extending through the annular projection; and an attachment means configured to extend through the attachment channel; wherein the cap body is configured to removably attach to the non-tapered segment of the auger body, the auger body further comprises an auger cavity, and the cap body further comprises a cap cavity, and the auger cavity and the cap cavity, in use, encapsulate the hunting tag.

Another aspect of the present invention includes the auger body further includes distal threads located on the tapered segment, wherein the distal threads are configured to selectively engage an orifice of the harvested animal.

Another aspect of the present invention includes the auger body further comprises proximal threads located on a proximal end of the non-tapered segment and comprises intermediate threads located on the non-tapered segment between the proximal threads and the distal threads, the cap body further comprises internal threads located at a distal end of the cap cavity, and the internal threads of the cap body are configured to be reversibly engageable with the proximal threads or the intermediate threads of the auger body.

Another aspect of the present invention includes, when the internal threads of the cap body are engaged with the proximal threads of the auger body, the hunting tag is encapsulated within the auger cavity and the cap cavity.

Another aspect of the present invention includes, when the internal threads of the cap body are engaged with the intermediate threads of the auger body, the tapered segment of the auger body is configured to be received within the cap cavity of the cap body.

Another aspect of the present invention includes the attachments means comprises a zip-tie.

Another aspect of the present invention includes the auger body and the cap body each are formed of a polymeric material.

In another aspect, any one or more aspects or features described herein may be combined with any one or more other aspects or features for additional advantage.

Other aspects and embodiments will be apparent from the detailed description and accompanying drawings.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A is a perspective view of a tag holding device according to a first embodiment of the present invention.

FIG. 1B is an exploded perspective view of the tag holding device of FIG. 1A.

FIG. 2 is a perspective view of an auger body of the tag holding device of FIG. 1A.

FIG. 3 is a right-side elevation section view of the auger body of FIG. 2.

FIG. 4 is a perspective view of a cap body of the tag holding device of FIG. 1A.

FIG. 5 is a right-side elevation section view of the cap body of FIG. 4.

FIG. 6 is a perspective view of the tag holding device of FIG. 1A, arranged in an alternative assembly.

FIG. 7 is a perspective view of the tag holding device of FIG. 1A, shown in situ in the ear of a harvested animal.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

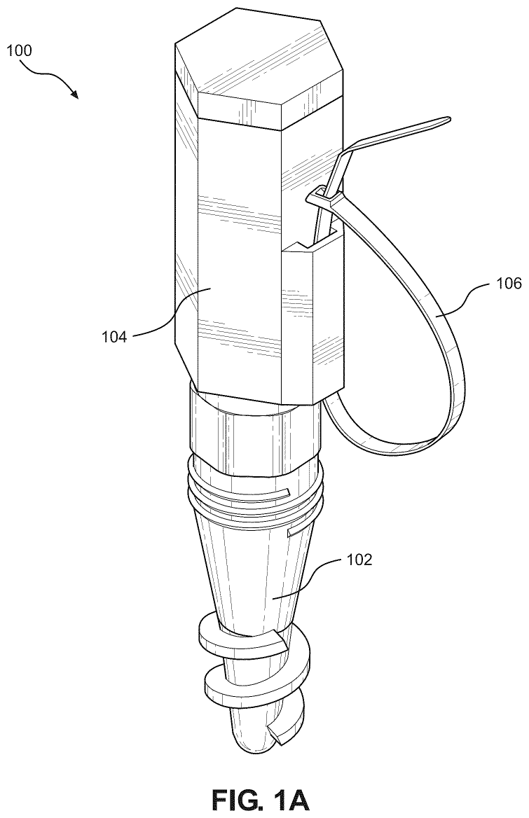

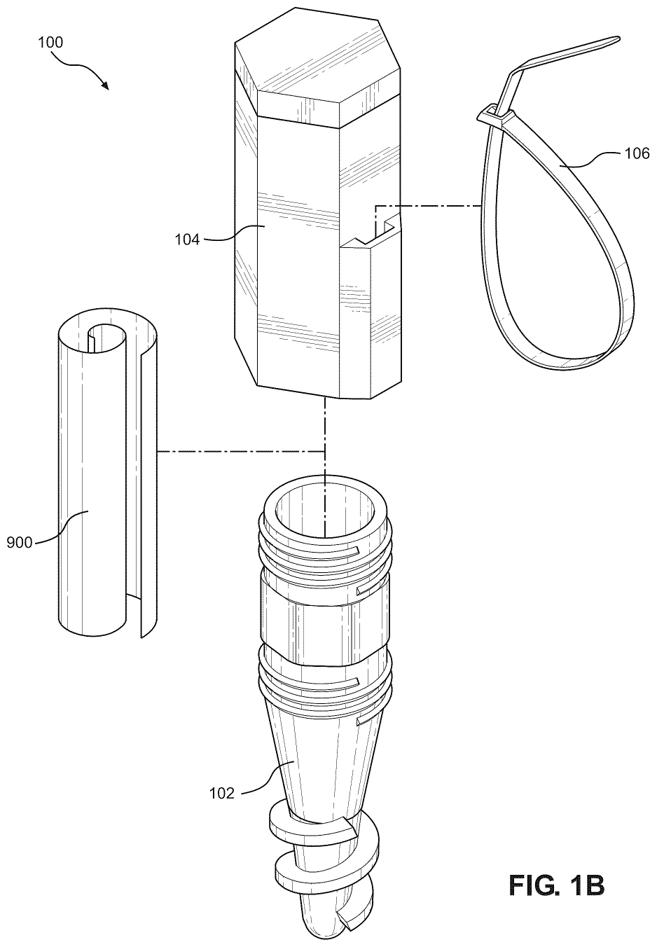

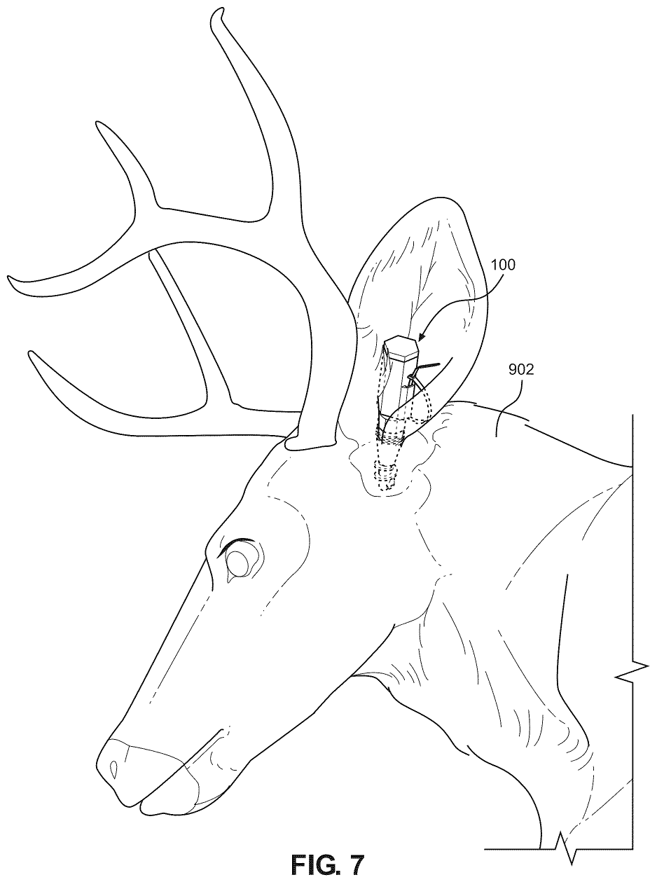

Referring now to FIGS. 1A-1B, a perspective view of a tag holding device 100 according to a first embodiment of the present invention is shown. The tag holding device 100 comprises an auger body 102, a cap body 104, and an attachment means 106. The auger body 102 and the cap body 104 are configured to securely encapsulate a hunting tag 900. The auger body 102 and the attachment means 106 are each further configured to provide attachment to a harvested animal 902 (see FIG. 7). In an exemplary embodiment, the auger body 102 and the cap body 104 are formed of a metal, a polymeric material, an elastomeric material, and/or any other suitable material.

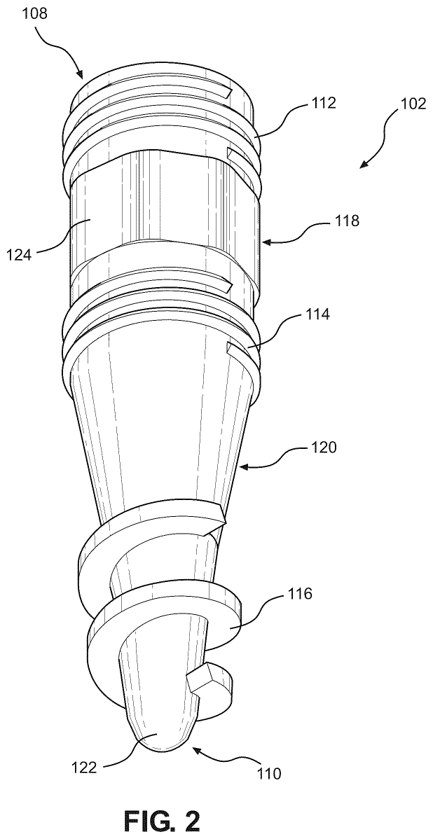

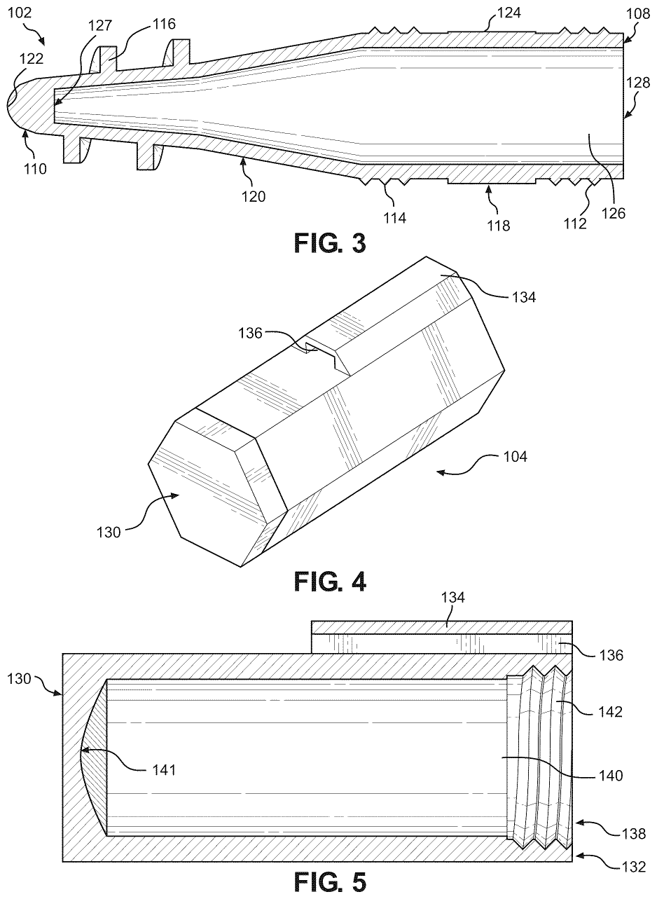

Referring now to FIGS. 2-3, the auger body 102 comprises an auger proximal end 108, an auger distal end 110, proximal threads 112, intermediate threads 114, and distal threads 116. In an exemplary embodiment, the proximal threads 112, the intermediate threads 114, and the distal threads 116 are located on an external surface of the auger body 102. In an exemplary embodiment, the proximal threads 112 are located at the auger proximal end 108 and the distal threads 116 are located at the auger distal end 110. In an exemplary embodiment, the intermediate threads 114 are located between the proximal threads 112 and the distal threads 116. In an exemplary embodiment, the proximal threads 112 and the intermediate threads 114 are configured identically. For example, the proximal threads 112 and the intermediate threads 114 are configured to have the same major diameter, pitch, thread angle, minor diameter, lead, and/or any other suitable thread parameter. In an exemplary embodiment, the distal threads 116 are configured to at least have a larger major diameter, larger pitch, a larger lead, and a smaller minor diameter relative to either of the proximal thread 112 and/or intermediate threads 114.

In an exemplary embodiment, the auger body 102 further comprises a non-tapered segment 118 and a tapered segment 120. In a preferred embodiment, the non-tapered segment 118 is located proximally relative to the tapered segment 120. In an exemplary embodiment, the proximal threads 112 and the intermediate threads 114 are located on the non-tapered segment 118. In an exemplary embodiment, the distal threads 116 are located on the tapered segment 120. In an exemplary embodiment, the tapered segment 120 is configured to taper from a diameter equal to a diameter of the non-tapered segment 118 to a reduced diameter, with the taper direction going from proximal to distal. In an exemplary embodiment, the tapered segment 120 may be configured with a constant taper. In an alternative embodiment, the tapered segment 120 may be configured with a variable or non-linear taper. In an exemplary embodiment, the distal end of the tapered segment 120 is configured with a rounded tip 122. In use, the auger body 102 is configured to be inserted into an orifice (such as an ear canal) of the harvested animal 902 (see FIG. 7). The auger distal end 110 is inserted first such that the rounded tip 122 of the tapered segment 120 enters the orifice first. The distal threads 116 are configured to engage a surface of the orifice of the harvested animal 902 to provide selective engagement therebetween.

In an exemplary embodiment, the non-tapered segment 118 further comprises a grip portion 124. The grip portion 124 is configured to have a different shape profile from a remainder of the non-tapered segment 118 (when viewed along a longitudinal axis of the auger body 102), so as to improve a user's ability to grasp and hold the auger body 102. In an exemplary embodiment, the grip portion 124 may be configured with a rounded square profile, a rounded pentagonal profile, a rounded hexagonal profile, a rounded heptagonal profile, a rounded octagonal profile, and/or any other suitable polygonal profile. In an exemplary embodiment, the grip portion 124 comprises a rounded hexagonal profile while the remainder of the non-tapered segment 118 is configured as a cylindrical shape.

In an exemplary embodiment, the auger body 102 further comprises an auger cavity 126 that extends from an auger opening 128 at the auger proximal end 108 to an auger cavity terminal end 127 adjacent the rounded tip 122. In an exemplary embodiment, the auger cavity 126 is configured such that the auger body 102 has a same or substantially a same wall thickness in the non-tapered segment 118 as the tapered segment 120. In use, the auger cavity 126 is sized and configured to at least partially encapsulate the hunting tag 900.

Referring now to FIGS. 4-5, the cap body 104 of the tag holding device 100 comprises a cap proximal end 130, a cap distal end 132, an annular projection 134, and an attachment channel 136. In an exemplary embodiment, the annular projection 134 extends from an external surface of the cap body 104. In an exemplary embodiment, the annular projection 134 extends at least partially along a length of the cap body 104 from the cap proximal end 130 to the cap distal end 132. In an exemplary embodiment, the annular projection 134 is configured to extend from the cap proximal end 130 towards the cap distal end 132, to extend from the cap distal end 132 towards the cap proximal end 130, or to extend entirely between the cap proximal end 130 and the cap distal end 132. The attachment channel 136 is configured to extend through the entirety of a length of the annular projection 134. In use, the attachment channel 136 is configured to receive the attachment means 106 therein. In an exemplary embodiment, the attachment means 106 is configured as a zip-tie, a safety pin, metal wire, and/or any other suitable selectively removable attachment means.

In an exemplary embodiment, the cap body 104 further comprises a cap opening 138 located at the cap distal end 132 and a cap cavity 140 extending from the cap opening 138 to a cap cavity terminal end 141 adjacent the cap proximal end 130. In use, the cap cavity 140 is sized and configured to at least partially encapsulate the hunting tag 900. In an exemplary embodiment, in use, the auger cavity 126 and cap cavity 140 cooperate to totally encapsulate the hunting tag 900.

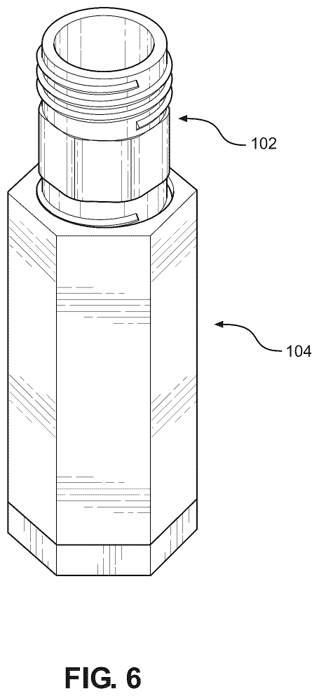

In an exemplary embodiment, the cap cavity 140 further comprises internal threads 142. The internal threads 142 are configured to engage the proximal threads 112 and/or the intermediate threads 114 of the auger body 102. In an exemplary embodiment, the cap cavity 140 has a diameter equal to an outside diameter of the non-tapered segment 118 of the auger body 102. In an exemplary embodiment, in use, the cap distal end 132 of the cap body 104 is configured to be placed over the auger proximal end 108 of the auger body 102 such that the internal threads 142 engage the proximal threads 112 (see FIG. 1A). In another exemplary embodiment, in use, the cap distal end 132 of the cap body 104 is configured to be placed over the auger distal end 110 of the auger body 102 such that the internal threads 142 engage the intermediate threads 114 (see FIG. 6). In this embodiment, a length between the cap opening 138 and the cap cavity terminal end 141 is greater than or equal to a length between a proximal side of the intermediate threads 114 to the rounded tip 122. In this embodiment, the distal threads 116 are located within the cap cavity 140, which are therefore protected during transport, storage, or the like.

In use, a hunter downs the harvested animal 902 during a hunt. The hunter places the hunting tag 900 within the auger cavity 126 of the auger body 102, then places the cap body 104 over the auger proximal end 108 such that internal threads 142 engage the proximal threads 112 and such that the hunting tag 900 is at least partially within the cap cavity 140. The hunter takes the tag holding device 100 and firmly inserts the tapered segment 120 into an orifice of the harvested animal 902 (such as through pressing or through screwing the tapered segment 120 into the orifice). Subsequently, the hunter creates a hole through the cartilage of the harvested animal 902 (such as the ear cartilage) and passes the attachment means 106 through the hole and through the attachment channel 136 before securing the attachment means 106 closed to provide further securement of the tag holding device 100 to the harvested animal 902.

Those skilled in the art will recognize improvements and modifications to the preferred embodiments of the present disclosure. All such improvements and modifications are considered within the scope of the concepts disclosed herein and the claims that follow.

What is claimed is:

1. A tag holding device for holding a hunting tag of a harvested animal, the tag holding device comprising:
an auger body comprising a non-tapered segment and a tapered segment located distal to the non-tapered segment;
a cap body having an annular projection and an attachment channel extending through the annular projection; and
an attachment means configured to extend through the attachment channel;
wherein:
the cap body is configured to removably attach to the non-tapered segment of the auger body,
the auger body further comprises an auger cavity, and the cap body further comprises a cap cavity, and
the auger cavity and the cap cavity, in use, encapsulate the hunting tag.

2. The tag holding device of claim 1, the auger body further comprising distal threads located on the tapered segment, wherein the distal threads are configured to selectively engage an orifice of the harvested animal.

3. The tag holding device of claim 2, wherein:
the auger body further comprises proximal threads located on a proximal end of the non-tapered segment and comprises intermediate threads located on the non-tapered segment between the proximal threads and the distal threads,
the cap body further comprises internal threads located at a distal end of the cap cavity, and
the internal threads of the cap body are configured to be reversibly engageable with the proximal threads or the intermediate threads of the auger body.

4. The tag holding device of claim 3, wherein, when the internal threads of the cap body are engaged with the proximal threads of the auger body, the hunting tag is encapsulated within the auger cavity and the cap cavity.

5. The tag holding device of claim 3, wherein, when the internal threads of the cap body are engaged with the intermediate threads of the auger body, the tapered segment of the auger body is configured to be received within the cap cavity of the cap body.

6. The tag holding device of claim 1, wherein the attachments means comprises a zip-tie.

7. The tag holding device of claim 1, wherein the attachment means comprises a safety pin.

8. The tag holding device of claim 1, wherein the auger body and the cap body each are formed of a polymeric material.
